(19) United States
(12) Patent Application Publication
(10) Pub. No.: US 2024/0306132 A1
(43) Pub. Date: Sep. 12, 2024

(54) CHANNEL ALLOCATION METHOD IN A COMMUNICATION NETWORK

(71) Applicant: MEDIATEK Inc., Hsinchu City (TW)

(72) Inventors: Yen-Shuo LU, Hsinchu City (TW); Ting-Che TSENG, Hsinchu City (TW); Wen-Chieh TSAI, Hsinchu City (TW)

(21) Appl. No.: 18/583,969

(22) Filed: Feb. 22, 2024

Related U.S. Application Data
(60) Provisional application No. 63/489,227, filed on Mar. 9, 2023.

(51) Int. Cl. H04W 72/0453; H04W 84/12

(52) U.S. Cl. CPC H04W 72/0453; H04W 84/12

(57) ABSTRACT

A channel allocation method for a communication device to perform in a wireless personal area network (WPAN) following IEEE 802.15 or SIG protocol, and the communication device is able to operate across a plurality of frequency bands. The channel allocation method includes the following steps. A working frequency band within the plurality of frequency bands is determined, the working frequency band includes at least one clean channel and other channels. One of the at least one clean channel is selected to operate in the WPAN, by the communication device. The at least one clean channel is not used by another communication device in a wireless local area network (WLAN) following IEEE 802.11 protocol.

This application claims the benefit of U.S. provisional application Ser. No. 63/489,227, filed Mar. 9, 2023, the subject matter of which is incorporated herein by reference.

### TECHNICAL FIELD

The present disclosure relates to a channel allocation mechanism, and more particularly, relates to a channel allocation method for a communication device to operate in a communication network.

### BACKGROUND

Wireless communication systems range from national and/or international cellular telephone systems to the Internet to point-to-point in-home wireless networks. Different types of wireless communication system operate in accordance with one or more communication protocols. Wireless communication systems, such as WLAN and WPAN, may operate in accordance with one or more protocol standards including, but not limited to, IEEE 802.11, 802.15, and/or variations thereof. These are used for wireless connections between different devices, such as connecting computers and peripheral devices such as printers, keyboards, etc.

In recent years, wireless communication technologies applied for WPAN have been developing very fast. For instance, Bluetooth system has extended frequency bands from 2.4 GHz to 5 GHz or 6 GHz. Meanwhile, Wi-Fi system has been using these same frequency bands with revolving protocols. Therefore, adaptive frequency hopping bands of Bluetooth may coexist with Wi-Fi frequency bands, thus a more efficient channel allocation method is desired to avoid negative interference between Wi-Fi frequency bands and Bluetooth adaptive frequency hopping bands.

### SUMMARY

In an aspect of the present disclosure, a channel allocation method is provided. The channel allocation method is for a communication device to perform in a wireless personal area network (WPAN) following IEEE 802.15 or SIG protocol, and the communication device is able to operate across a plurality of frequency bands. The channel allocation method includes the following steps. A working frequency band within the plurality of frequency bands is determined, the working frequency band includes at least one clean channel and other channels. One of the at least one clean channel is selected to operate in the WPAN, by the communication device. The at least one clean channel is not used by another communication device in a wireless local area network (WLAN) following IEEE 802.11 protocol.

### BRIEF DESCRIPTION OF THE DRAWINGS

FIG. 1 is a schematic diagram illustrating an operating environment for a first communication network according to an embodiment of the present disclosure.

FIG. 2 is a schematic diagram illustrating a spectrum for a first communication network in FIG. 1.

FIG. 3 is a schematic diagram illustrating a spectrum for the first communication network at another region, according to another embodiment of the present disclosure.

FIG. 4 is a schematic diagram illustrating a spectrum for the first communication network at still another region, according to still another embodiment of the present disclosure.

FIG. 5 is a flow diagram of a channel allocation method performed by the first communication device according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

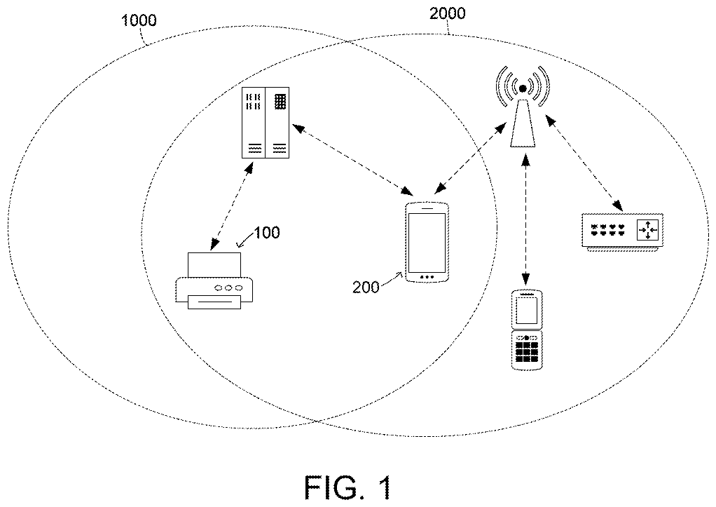

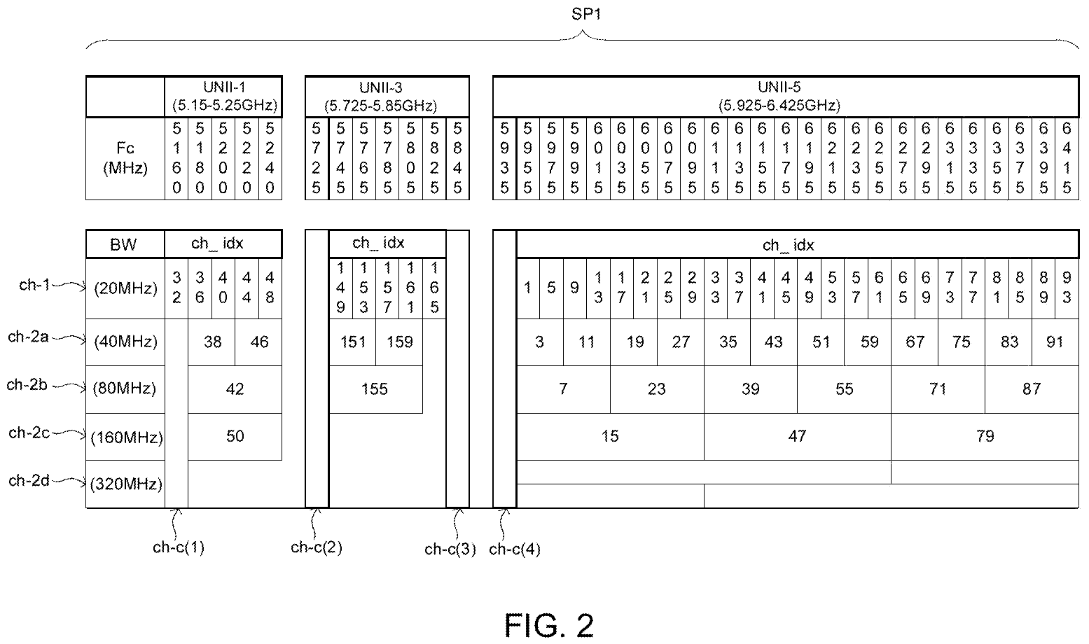

FIG. 1 is a schematic diagram illustrating an operating environment for a first communication network 1000 according to an embodiment of the present disclosure. FIG. 2 is a schematic diagram illustrating a spectrum SP1 for a first communication network 1000 in FIG. 1. Referring to both FIGS. 1 and 2, the first communication network 1000 is, e.g., a wireless personal area network (WPAN) which may follow the IEEE 802.15 or SIG protocol. The spectrum SP1 for the first communication network 1000 may cover several Unlicensed National Information Infrastructure (UNII) frequency bands, e.g., a UNII-1 band, a UNII-3 band and a UNII-5 band. Furthermore, each of these UNII frequency bands may include several sub-bands.

According to a region the first communication network 1000 is located, these UNII frequency bands may have different frequency ranges. Such as, when the first communication network 1000 is located in the United States, the UNII-1 band may range approximately from 5150 MHz to 5250 MHz, which includes five sub-bands with center frequencies of 5160 MHz, 5180 MHZ, 5200 MHz, 5220 MHz and 5240 MHz respectively. Furthermore, the UNII-3 band may range approximately from 5725 MHz to 5850 MHz, which includes five sub-bands with center frequencies of 5725 MHZ, 5745 MHz, 5765 MHz, 5785 MHz, 5805 MHz, 5825 MHz and 5845 MHz respectively. Moreover, the UNII-5 band may range approximately from 5925 MHz to 6425 MHz, which includes twenty-four sub-bands with center frequencies of 5935 MHz to 6415 MHz respectively.

The first communication network 1000 may be adapted for a Bluetooth system which is a frequency hopping system. When operating in the first communication network 1000, a first communication device 100 (e.g., a computer or a peripheral device, etc.) may perform an adaptive frequency hopping mechanism so as to operate across some or all of the sub-bands of the UNII-1 band, the UNII-3 band and the UNII-5 band in the spectrum SP1. These frequency bands, across which the first communication device 100 may adaptively hop, are referred to as “adaptive frequency hopping bands”.

The spectrum SP1 for the first communication network 1000 may overlap with a second communication network 2000, e.g., a wireless local area network (WLAN) for a Wi-Fi system, which follows the IEEE 802.11 protocol. Hence, these adaptive frequency hopping bands of the first communication network 1000 may coexist with some or all frequency bands of the second communication network 2000. In order to avoid undesired interferences between the first communication network 1000 and the second communication network 2000, the first communication device 100 may perform a channel allocation mechanism to select a proper channel within the frequency bands in the spectrum SP1.

In the channel allocation mechanism of the first communication device 100, initially, a “working frequency band” among the UNII-1 band, the UNII-3 band and the UNII-5 band in the spectrum SP1 is determined. The determined working frequency band may include at least one “clean channel” and other channels. Thereafter, one of the clean channel(s) is selected for the first communication device 100 to operate in the first communication network 1000. The clean channel(s) may not be used by any other devices (e.g., a second communication device 200) in the second communication network 2000, hence the first communication device 100 and other devices (e.g., the second communication device 200) may not interfere with each other.

More particularly, in the embodiment of FIG. 2, the UNII-1 band of the first communication network 1000 may include several first channels ch-1 with channel indexes (i.e., noted as “ch_idx” in FIG. 2) of “32”, “36”, “40”, “44” and “48” respectively. Each of the first channels ch-1 in the UNII-1 band has a bandwidth (i.e., noted as “BW” in FIG. 2) substantially equal to 20 MHZ, therefore each of the first channels ch-1 may be referred to as a “20 MHz channel”. The first channels ch-1 in the UNII-1 band indexed as “32”, “36”, “40”, “44” and “48” have center frequencies (i.e., noted as “Fc” in FIG. 2) substantially equal to 5160 MHz, 5180 MHz, 5200 MHZ, 5220 MHz and 5240 MHz respectively. These first channels ch-1 may follow a channel allocation of the protocol for the second communication network (e.g., the IEEE 802.11 protocol for Wi-Fi system).

In addition, the UNII-1 band may include several second channels ch-2a, ch-2b and ch-2c with bandwidths substantially equal to 40 MHz, 80 MHz and 160 MHz. Such as, each of the second channels ch-2a with channel indexes of “38” and “46” has a 40 MHz bandwidth. The second channel ch-2b with channel index of “42” has 80 MHz bandwidth, and the second channel ch-2c with channel index of “50” has a 160 MHz bandwidth. These second channels ch-2a to ch-2c may also follow the channel allocation of the protocol for the second communication network 2000.

On the other hand, the UNII-1 band may include one clean channel ch-c(1) which is aligned with one of the first channels ch-1. In the embodiment of FIG. 2, the clean channel ch-c(1) is aligned with the first channel ch-1 indexed as “32”, and the clean channel ch-c(1) is not overlapping with any of the second channels ch-2a to ch-2c. In contrast to the clean channel ch-c(1), the first channels ch-1 and the second channels ch-2a to ch-2c are referred to as “available channels”.

When performing the channel allocation mechanism, the first communication device 100 determines a working frequency band among the UNII-1 band, the UNII-3 band and the UNII-5 band in the spectrum SP1. Such as, the UNII-1 band may be determined as the working frequency band, and the clean channel ch-c(1) may be selected for the first communication device 100 to operate in the first communication network 1000. When the first communication device 100 establishes a connection in the first communication network 1000, the first communication device 100 may use the selected clean channel ch-c(1) to convey probe signals and control signals. The first channel ch-1 indexed as “32” with which the clean channel ch-c(1) is aligned, is closest to the center frequency 5160 MHz in the working frequency band (i.e., the UNII-1 band).

Likewise, in other examples, when the UNII-5 band is determined as the working frequency band, the clean channel ch-c(4) within the UNII-5 band may be selected by the first communication device 100 for operation. The clean channel ch-c(4) is aligned with the center frequency 5935 MHz. The UNII-5 band also includes several second channels which are not overlapping with the clean channel ch-c(4), and these second channels each has a bandwidth greater than or equal to 40 MHz and follow the channel allocation of the second communication network 2000. Such as, the second channels ch-2a indexed as “3”, “11”, “19”, “27”, “35, “43”, “51”, “59”, “67”, “75”, “83”, and “91” each has a 40 MHz bandwidth. The second channels ch-2b indexed as “7”, “23”, “39”, “55”, “71 and “87” each has a 80 MHz bandwidth. Moreover, the second channels ch-2c indexed as “15”, “47” and “79” each has a 160 MHz bandwidth.

In the aforementioned examples of channel allocation mechanism, only one clean channel is selected. Alternatively, two or more clean channels may be selected. Such as, when the first communication device 100 determines the UNII-3 band as the working frequency band, two clean channels ch-c(2) and ch-c(3) aligned with the center frequencies 5725 MHz and 5845 MHz, are both provided for the first communication device 100 to select. These two clean channels ch-c(2) and ch-c(3) are not overlapping with the second channels ch-2a of 40 MHz bandwidth (indexed as “151” and “159”) and the second channel ch-2b of 80 MHz bandwidth (indexed as “155”). The first communication device 100 may select one or two of from the clean channels ch-c(2) and ch-c(3). The total number of selected clean channel(s) may be limited based on traffic conditions, e.g., existing traffic conditions of 20 MHz channels which clean channels ch-c(2) and ch-c(3) are aligned with. When the first communication device 100 detects that some of 20 MHz channels have heavy traffic, less number of clean channel(s) is/are selected to reduce power consumption.

As aforementioned, the frequency bands in the spectrum SP1 may have different frequency ranges depending on where the first communication network 1000 and the first communication device 100 are located. Before performing the channel allocation mechanism, the first communication device 100 may obtain the frequency ranges of the frequency bands based on a system location information related to the first communication network 1000.

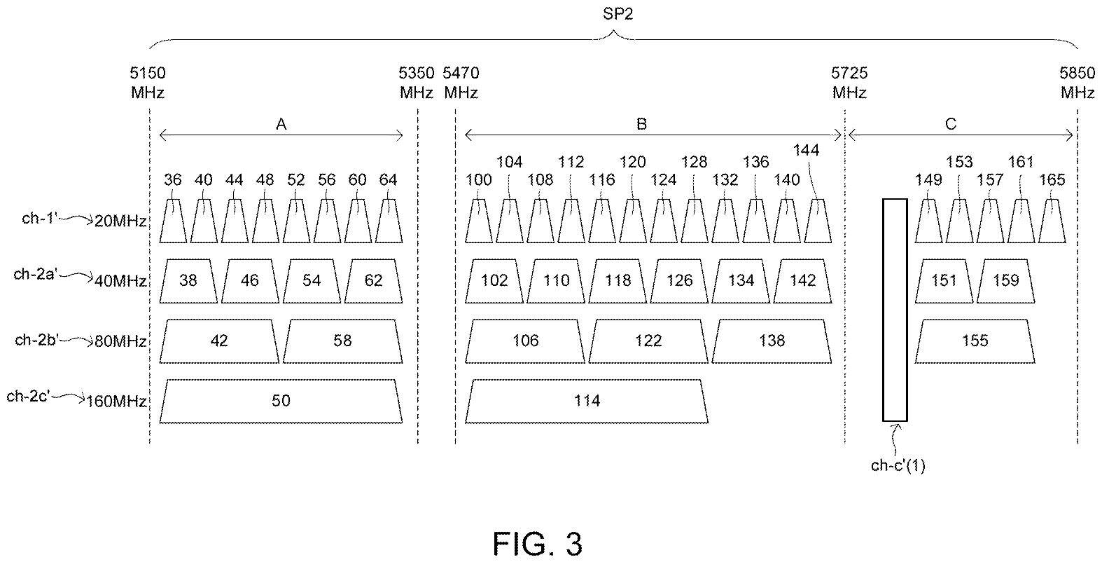

Next, referring to FIG. 3, which is a schematic diagram illustrating a spectrum SP2 for the first communication network 1000 at another region, according to another embodiment of the present disclosure. In this embodiment, the first communication network 1000 and the first communication device 100 are located in the United Kingdoms. Based on the system location information of the first communication network 1000, the first communication device 100 is aware that the spectrum SP2 for the first communication network 1000 may cover approximately from 5.15 GHz to 5.85 GHz and include three frequency bands A, B and C. Usages and center frequencies of the frequency bands A, B and C in the spectrum SP2 are listed in Table 1.

TABLE 1

| Band | Channel index | Center freq. (MHz) | Usage |
|---|---|---|---|
| A | 36 | 5180 | Indoor |
| A | 40 | 5200 | Indoor |
| A | 44 | 5220 | Indoor |
| A | 48 | 5240 | Indoor |
| A | 52 | 5260 | Indoor |
| A | 56 | 5280 | Indoor |
| A | 60 | 5300 | Indoor |
| A | 64 | 5320 | Indoor |
| B | 100 | 5500 | Indoor/Outdoor |
| B | 104 | 5520 | Indoor/Outdoor |
| B | 108 | 5540 | Indoor/Outdoor |
| B | 112 | 5560 | Indoor/Outdoor |
| B | 116 | 5580 | Indoor/Outdoor |
| B | 120 | 5600 | Indoor/Outdoor |
| B | 124* | 5620 | Indoor/Outdoor |
| B | 128* | 5640 | Indoor/Outdoor |
| B | 132 | 5660 | Indoor/Outdoor |
| B | 136 | 5680 | Indoor/Outdoor |
| B | 140 | 5700 | Indoor/Outdoor |
| B/C | 144 | 5720 | Indoor/Outdoor |
| C | 149 | 5745 | Indoor/Outdoor |
| C | 153 | 5765 | Indoor/Outdoor |
| C | 157 | 5785 | Indoor/Outdoor |
| C | 161 | 5805 | Indoor/Outdoor |
| C | 165 | 5825 | Indoor/Outdoor |

As shown in Table 1 (also referring to FIG. 3), the frequency band A ranges approximately from 5.15 GHz to 5.35 GHz, the frequency band B ranges approximately from 5.47 GHz to 5.725 GHZ, and the frequency band C ranges approximately from 5.725 GHz to 5.85 GHz. Each of the frequency bands A, B and C may include several 20 MHz channels and other channels with greater bandwidths. Such as, the frequency band A may include eight 20 MHz channels indexed as “36” to “64”, four 40 MHz channels indexed as “38” to “62”, two 80 MHz channels indexed as “42” and “58”, and one 160 MHz channel indexed as “50”.

Likewise, the frequency band B may include twelve 20 MHz channels indexed as “100” to “144”, six 40 MHz channels indexed as “102” to “142”, three 80 MHz channels indexed as “106” to “138”, and one 160 MHz channel indexed as “114”. Moreover, the frequency band C may include five 20 MHz channels indexed as “149” to “165”, two 40 MHz channels indexed as “151” and “159”, and one 80 MHz channel indexed as “155”. The 20 MHz channels in the frequency bands A, B and C are also referred to as first channels ch-1′, which may correspond to the first channels ch-1 in FIG. 2. Likewise, the 40 Mhz, 80 MHZ and 160 MHz channels in the frequency bands A, B and C are also referred to as second channels ch-2a′, ch-2b′ and ch-2c′, which may correspond to the second channels ch-2a to ch-2c in FIG. 2. The 20 MHZ, 40 Mhz, 80 MHZ and 160 MHz channels in the frequency bands A, B and C may follow a channel allocation of the protocol for the second communication network 2000.

On the other hand, the frequency bands A, B and C may also include clean channels which may not overlap with the 40 Mhz, 80 MHZ and 160 MHz channels. Such as, the frequency band C may include a clean channel ch-c′ with a frequency range lower than the channels indexed as “149” and “151”. When performing a channel allocation mechanism for the spectrum SP2, the first communication device 100 may firstly determine a working frequency band among the frequency bands A, B and C. Then, the first communication device 100 may select one of the clean channels in the determined working frequency band, where the selected clean channel is not used by the second communication device 200 in the second communication network 2000.

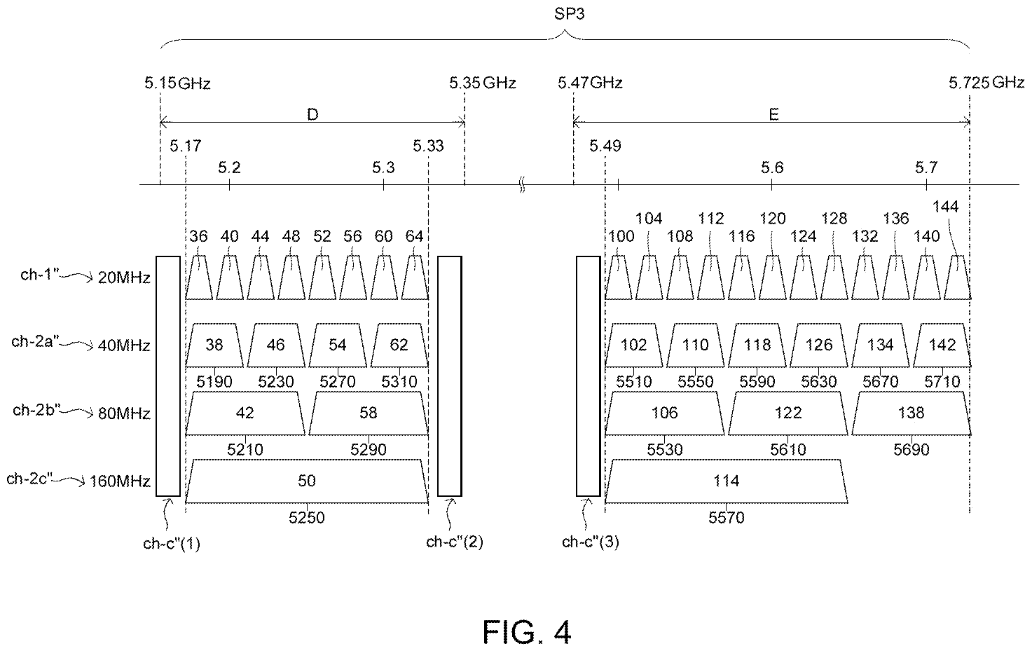

Next, referring to FIG. 4, which is a schematic diagram illustrating a spectrum SP3 for the first communication network 1000 at still another region, according to still another embodiment of the present disclosure. In this embodiment, the first communication network 1000 and the first communication device 100 are located in Japan. The spectrum SP3 for the first communication network 1000 ranges approximately from 5.15 GHz to 5.725 GHz which includes two frequency bands D and E.

The frequency band D ranges approximately from 5.15 GHz to 5.35 GHz, which includes eight 20 MHz channels indexed as “36” to “64”, four 40 MHz channels indexed as “38” to “62”, two 80 MHz channels indexed as “42” and “58”, and one 160 MHz channel indexed as “50”. The 20 MHz channels may be referred to as the first channels ch-1″, which may correspond to the first channels ch-1 in FIG. 2 and the first channels ch-1′ in FIG. 3. Furthermore, the 40 MHz, 80 MHz and 160 MHz channels may be referred to as the second channels ch-2a″ to ch-2c″, which may correspond to the second channels ch-2a to ch-2c in FIG. 2 and the second channels ch-2a′ to ch-2c′ in FIG. 3. Furthermore, the frequency band D includes clean channels ch-c″(1) and ch-c″(2) ranges approximately from 5.15 GHz to 5.17 GHz and 5.33 GHz to 5.35 GHz. The clean channels ch-c″(1) and ch-c″(2) are not overlapping with the 40 MHz, 80 Mhz and 160 MHz channels.

Another frequency band E ranges approximately from 5.47 GHz to 5.725 GHz. In the frequency band E, twelve 20 MHz channels indexed as “100” to “144” may be referred to as the first channel ch-1″. Furthermore, six 40 MHz channels indexed as “102” to “142”, three 80 MHz channels indexed as “106” to “138” and one 160 MHz channel indexed as “114” may be referred to as the second channels ch-2a″ to ch-2c″. Moreover, the frequency band E includes a clean channel ch-c″(3) ranges from 5.47 GHz to 5.49 GHz.

When performing the channel allocation mechanism, the first communication device 100 determines a working frequency band from the frequency bands D and E, then selects a clean channel in the determined working frequency band. Such as, the frequency band D is determined as the working frequency band, within which the clean channel ch-c″(1) is selected. The 20 MHz, 40 MHZ, 80 MHz and 160 MHz channels may follow a channel allocation of the second communication network 2000, and the clean channel ch-c″(1) is not overlapping with the 40 MHz, 80 MHz and 160 MHz channels and is not used by the second communication network 200 in the second communication network 2000.

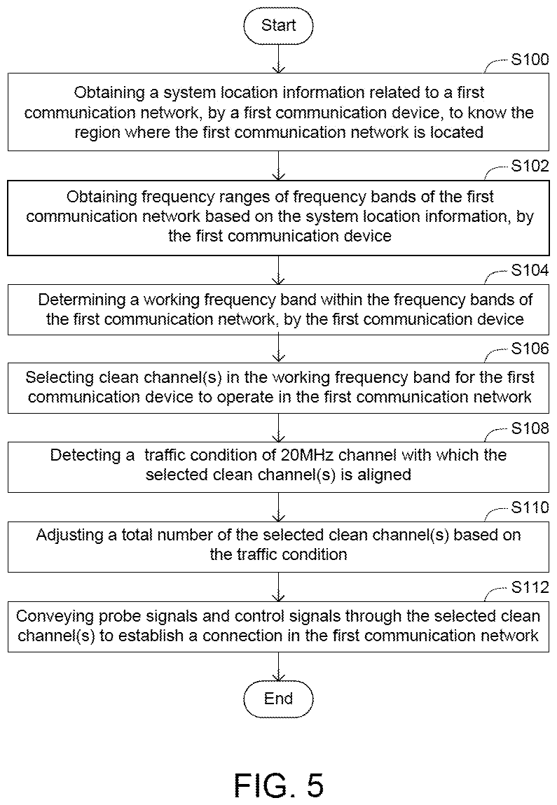

Next, referring to FIG. 5, which is a flow diagram of a channel allocation method performed by the first communication device 100 according to an embodiment of the present disclosure. The channel allocation method shown in FIG. 5 may correspond to the channel allocation mechanism as described in the embodiments with FIGS. 1 to 4.

With the embodiment of FIG. 2 as an example, the channel allocation method in FIG. 5 may be performed when the first communication device 100 operates with frequency hopping across several frequency bands (i.e., the UNII frequency bands) of the spectrum SP1 of the first communication network 1000 (e.g., a WPAN which follows the IEEE 802.15 protocol for the Bluetooth system). Firstly, in step S100, a system location information related to the first communication network 1000 is obtained by the first communication device 100, realizing where the first communication network 1000 and the first communication device 100 are located.

Then, in step S102, frequency ranges of the frequency bands in the spectrum SP1 are obtained by the first communication device 100 based on the system location information. Such as, based on the system location information, the first communication device 100 knows that the first communication network 1000 is located in the United States, and the spectrum SP1 includes UNII-1, UNII-3 and UNII-5 bands each including at least one clean channels, several 20 MHz channels (i.e., the first channels ch-1) and several 40 MHz to 160 MHz channels (i.e., the second channels ch-2a to ch-2c). Then, in step S104, a working frequency band within the frequency bands is determined by the first communication device 100. Such as, the UNII-3 band is determined as the working frequency band. The UNII-3 band include two clean channels ch-c(2) and ch-c(3).

Then, in step S106, at least one of the clean channels ch-c(2) and ch-c(3) is selected by the first communication device 100 to operate in the first communication network 1000. Such as, the clean channel ch-c(2) is selected, which may be aligned with a 20 MHz channel following a channel allocation of a second communication network 2000 (e.g., a WLAN which follows the IEEE 802.11 protocol for the Wi-Fi system). Furthermore, the clean channel ch-c(2) is not overlapping with the 40 MHz and 80 MHz channels. Moreover, the clean channel ch-c(2) is not used by the second communication device 200 in the second communication network 2000.

Then, in step S108, the first communication device 100 may detect a traffic condition of 20 MHz channel with which the clean channel is aligned. Then, in step S110, the first communication device 100 may adjust a total number of the selected clean channel(s) based on the traffic condition of the 20 MHz channel. Then, in step S112, the first communication device 100 may convey probe signals and control signals through the selected clean channel(s) to establish a connection in the first communication network 1000.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A channel allocation method for a communication device to perform in a wireless personal area network (WPAN) following IEEE 802.15 or SIG protocol, wherein the communication device is able to operate across a plurality of frequency bands, and the channel allocation method comprising:
determining a working frequency band within the plurality of frequency bands, wherein the working frequency band comprises at least one clean channel and other channels; and
selecting one of the at least one clean channel to operate in the WPAN, by the communication device;
wherein, the at least one clean channel is not used by another communication device in a wireless local area network (WLAN) following IEEE 802.11 protocol.

2. The channel allocation method according to claim 1, wherein the communication device is operating with frequency hopping, and the working frequency band is one of the Unlicensed National Information Infrastructure (UNII) frequency bands depending on a region the communication device locates.

3. The channel allocation method according to claim 1, wherein the at least one clean channel of the working frequency band is able to be used to convey probe signals and control signals by the communication device in order to establish a connection in WPAN.

4. The channel allocation method according to claim 3, wherein the at least one clean channel is aligned with a 20 MHz channel following channel allocation of IEEE 802.11 protocol; wherein, the 20 MHz channel is the channel closest to a center frequency in the working frequency band.

5. The channel allocation method according to claim 4, wherein the step of selecting one of the at least one clean channel to operate in the WPAN further comprises:
limiting a total number of the clean channels to operate in the WPAN based on an existing traffic condition of the 20 MHz channel.

6. The channel allocation method according to claim 5, wherein the working frequency band comprises a plurality of second channels other than the at least one clean channel, the plurality of second channels also follow channel allocation of IEEE 802.11 protocol.

7. The channel allocation method according to claim 6, wherein the second channels are substantially equal to 40 MHz, 80 MHz or greater bandwidths.

8. The channel allocation method according to claim 6, wherein the at least one clean channel is not overlapping with the second channels.
